(19) United States
(12) Patent Application Publication
(10) Pub. No.: US 2007/0194002 A1
(43) Pub. Date: Aug. 23, 2007

(54) RACK SENSOR

(75) Inventors: Gary Fisher, GOODLETTSVILLE, TN (US); James Marler, Greenbrier, TN (US); Ronald G. Brant, Greenbrier, TN (US)

Correspondence Address: PEARNE & GORDON LLP, 1801 EAST 9TH STREET, SUITE 1200, CLEVELAND, OH, 44114-3108, US

(73) Assignee: ELECTROLUX HOME PRODUCTS, INC., CLEVELAND, OH (US)

(21) Appl. No.: 11/678,907

(22) Filed: Feb. 26, 2007

Related U.S. Application Data
(63) Continuation-in-part of application No. 11/087,311, filed on Mar. 23, 2005, now Pat. No. 7,183,521.
(60) Provisional application No. 60/558,272, filed on Mar. 31, 2004.

(51) Int. Cl. A21B 1/22

(52) U.S. Cl. 219/400

(57) ABSTRACT

An appliance includes a cavity having one or more rack structures therein. One or more rack sensors are operatively coupled to the appliance cavity to sense a presence or absence of the one or more rack structures within the cavity.

### CROSS REFERENCE TO RELATED APPLICATIONS

This application is a continuation-in-part of U.S. patent application Ser. No. 11/087,311 filed on Mar. 23, 2005 and entitled RACK SENSOR, which claims the benefit of U.S. Provisional Patent Application No. 60/558,272, filed on Mar. 31, 2004 and entitled RACK SENSOR.

### BACKGROUND OF THE INVENTION

1) Field of the Invention

The present invention relates to appliances, and more particularly, to an appliance having a sensor configured to detect the presence or absence of one or more racks within the appliance.

2) Description of Prior Art

Various appliances designed for household uses are provided with one or more racks for supporting items. The racks are generally provided within a cavity of the appliance and are typically removable and adjustable within the cavity.

For instance, cooking appliances typically includes one or more racks for supporting food items to be cooked within an oven cavity. The oven cavity itself is generally provided with sidewall rails for supporting respective lateral sides of the rack, while permitting the rack to be vertically adjusted. That is, the rack can slide along a selected set of support rails for movement into and out of the oven cavity, with the rack also being removable for cleaning and or repositioning at a different height.

Oven racks are often of wire construction. More specifically an outer wire frame and support platform, which includes a plurality of fore-to-aft and laterally spaced wires, define a typical oven rack. The wires are spaced across the rack for use in supporting food items to be cooked.

The racks and the sidewall rails all may be removable for ease of cleaning outside of the oven and to protect both the appearance and any moveable portions of the rack structure during an oven self-cleaning (pyrolysis). Unfortunately, users tend to leave the structure in place. The presence of the rack structure in the oven during a cleaning cycle results in discoloration of the rack structure and degradation of any moving parts.

### SUMMARY OF THE INVENTION

The following presents a simplified summary of the invention in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In accordance with an aspect of the present invention, an appliance is provided. The appliance includes: a housing, a cavity within the housing, the cavity being configured to receive at least one removable structure therein, and at least one sensor configured to detect the presence and/or absence of the at least one removable structure within the cavity.

In accordance with another aspect of the present invention, a method of operating an appliance is provided. The method includes: requesting a desired function; sensing an absence or presence of a removable structure within a cavity portion of the appliance; and providing notification to a user of the absence or presence of the removable structure within the cavity portion of the appliance.

In accordance with yet another aspect of the present invention, an appliance is provided. The appliance includes means for detecting a presence or absence of a removable structure within a cavity portion of the appliance; and notification means for alerting a user of the presence of absence of the removable structure within the cavity portion of the appliance.

The following description and the annexed drawings set forth in detail certain illustrative aspects of the invention. These aspects are indicative, however, of but a few of the various ways in which the principles of the invention may be employed and the present invention is intended to include all such aspects and their equivalents. Other objects, advantages and novel features of the invention will become apparent from the following detailed description of the invention when considered in conjunction with the drawings.

### BRIEF DESCRIPTION OF THE DRAWINGS

The foregoing and other features and advantages of the present invention will become apparent to those skilled in the art to which the present invention relates upon reading the following description with reference to the accompanying drawings.

FIG. 1 illustrates an appliance cavity in accordance with an aspect of the present invention.

FIG. 2 illustrates an appliance cavity in accordance with an aspect of the present invention.

FIG. 3 illustrates an appliance having a rack sensor in accordance with an aspect of the present invention.

FIG. 4 illustrates a rack sensor operatively coupled to an appliance control in accordance with an aspect of the present invention.

FIG. 5 illustrates a rack sensor operatively coupled to an indicator in accordance with an aspect of the present invention.

FIG. 6 illustrates a rack sensor engaging a rack structure in accordance with an aspect of the present invention.

FIG. 7 illustrates a portion of the rack sensor protruding into an appliance cavity in accordance with an aspect of the present invention.

FIG. 8 illustrates a portion of the rack sensor positioned outside the appliance cavity in accordance with an aspect of the present invention.

FIG. 9 illustrates a methodology of using a rack sensor in accordance with an aspect of the present invention.

FIG. 10 illustrates another methodology of using a rack sensor in accordance with an aspect of the present invention.

### DESCRIPTION OF AN EXAMPLE EMBODIMENT

The present invention relates to a sensing device to detect the presence or absence of one or more racks within an appliance. The present invention will now be described with reference to the drawings, wherein like reference numerals are used to refer to like elements throughout. It is to be appreciated that the various drawings are not drawn to scale from one figure to another nor inside a given figure, and in particular that the size of the components are arbitrarily drawn for facilitating the reading of the drawings. In the following description, for purposes of explanation, numerous specific details are set forth in order to provide a thorough understanding of the present invention. It may be evident, however, that the present invention may be practiced without these specific details.

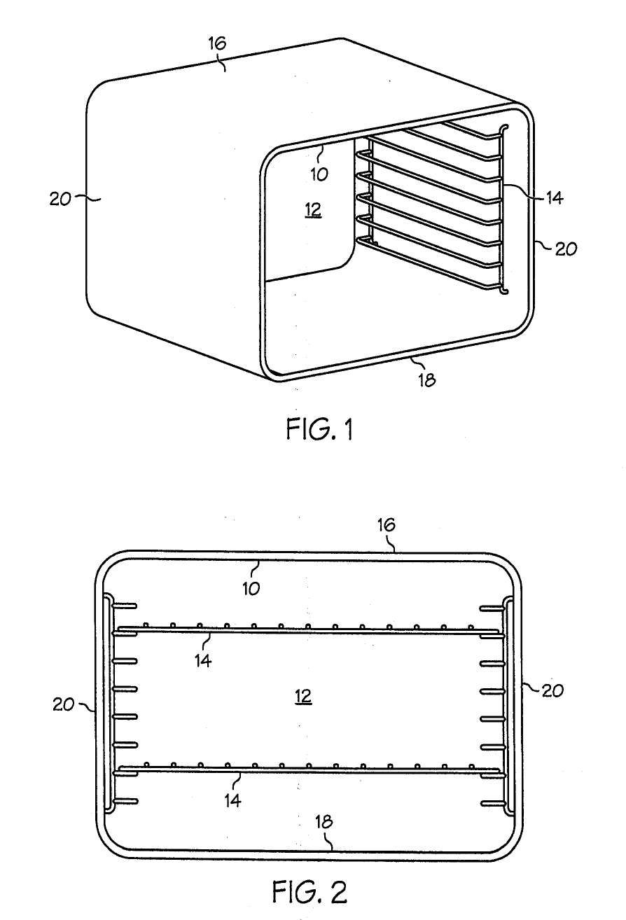

Referring initially to FIGS. 1 and 2, a portion of an appliance is depicted in accordance with an aspect of the present invention. The appliance includes a cabinet 10 having a cavity 12 therein and at least one rack structure 14 positioned within the cavity 12. In the present example, the appliance is an oven. The cavity 12 is defined by a bottom wall 16, an upper wall 18, and opposing side walls 20. Each of the opposing side walls 20 can include a ladder rack structure 14, as shown in FIG. 1. Additionally, or alternatively, the cavity can be provided with one or more support rack structures 14 used for bearing food items and the like, as shown in FIG. 2. The support racks 14 can be configured to engage ladder rack structures, such as the one depicted in FIG. 1, or can be configured to engage guide rails formed in or on the sidewalls 20 of the appliance cavity 12. Further, the support racks 14 can be of a conventional design having no moving parts and/or can include racks with moving parts, such as glide racks, half racks, turntable racks, and the like.

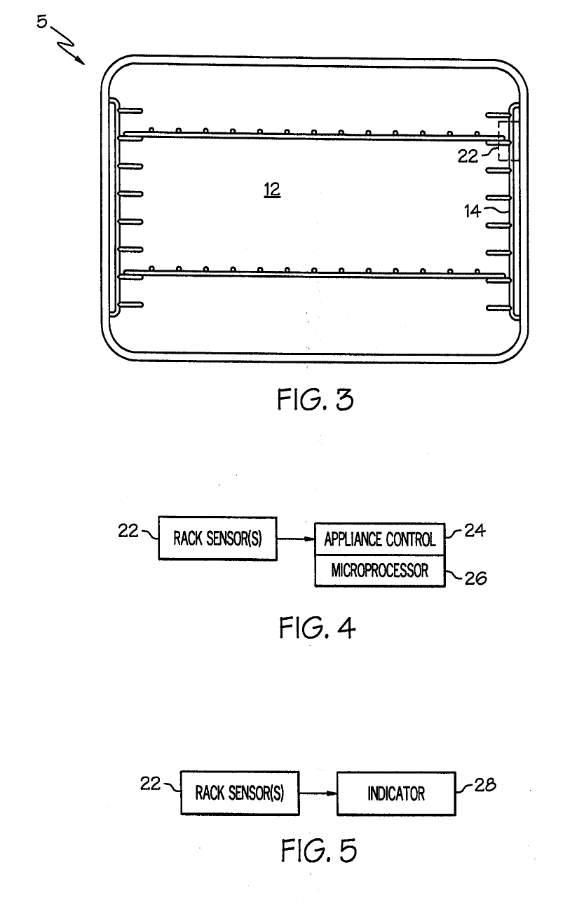

Turning now to FIG. 3, one or more rack sensors 22 are coupled to the appliance 5 in accordance with an aspect of the present invention. The one or more rack sensors 22 are configured to sense the presence of absence of one or more of the rack structures 14 and can be coupled to the appliance in any suitable location. As shown in FIG. 4, the rack sensor(s) 22 can be connected to an appliance control 24, which may advantageously include a microprocessor 26, so that a user is prevented from engaging a desired function, such as self-clean, when the rack structure(s) 14 is present in the appliance cavity 12. In the present oven example, preventing the user from engaging the self-clean function when the rack structure(s) 14 is in place mitigates damage, such as discoloration of the rack structure(s) 14 and/or degradation of any moving parts of the rack structure(s) 14. When the rack structure(s) 14 is removed from or placed in the oven cavity 12, the sensor(s) 22 can send a change of state signal to the processor 26 or the oven control 24, which can either enable or disable a clean operation depending upon the information received. It should be noted that this control architecture is merely an example; the function being provided may be implemented in many configurations.

Alternatively, as depicted in FIG. 5, the rack sensor(s) 22 can be connected to an indicator device 28, so that when the user engages the desired function (e.g., self-clean) in which the rack structure(s) 14 should not be present in the appliance cavity 12, the user can be warned with an audio and/or visual signal. Such an alert can be sounded or otherwise provided once when initially engaging the desired function, or at intermittent time intervals to provide the user of a continuous reminder that the rack structure(s) 14 should be removed. In other words, the user will not be forced to remove the rack structure(s) 14 prior to operation of the desired function, but will be warned that any rack structure(s) 14 should be removed.

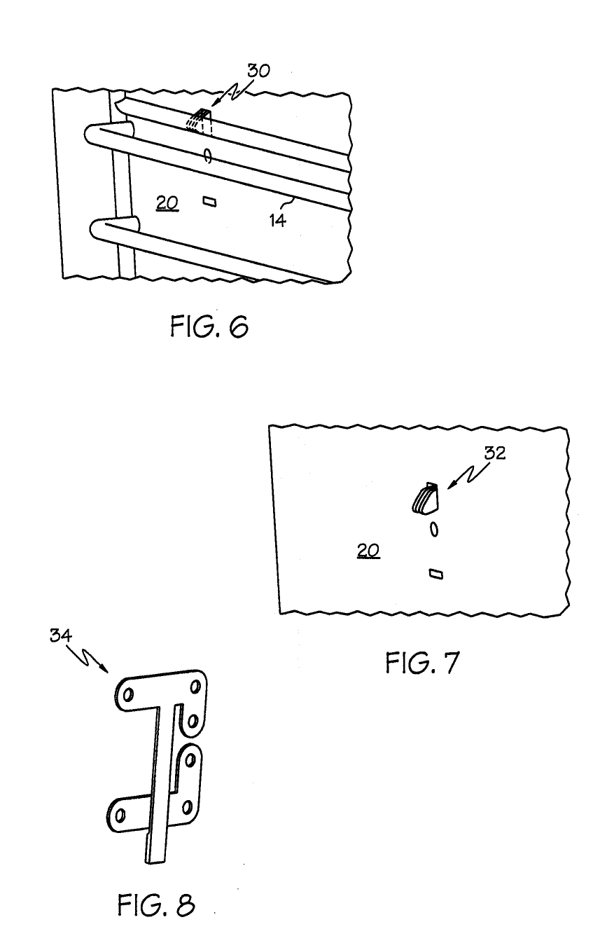

The rack sensor(s) 22 may be any suitable sensor such as, for example, a mechanical switch located at any suitable position to sense the presence or absence of the rack structure(s) 14. Other possible sensors may be, for example, optical switches, magnetic switches, proximity switches, and ultrasonic switches as well as applications where the rack structure(s) itself completes a circuit. Turning now to FIGS. 6-8, an example of a rack sensor 30 that can be employed is illustrated in accordance with an aspect of the present invention. The rack sensor 30 is mounted to a sidewall 20 of the appliance cavity 12 such that a first portion 32 of the sensor 30 is positioned outside of the appliance cavity 12 and a second portion 34 protrudes into the appliance cavity 12. The configuration shown allows the sensor 30 to be coupled to the oven cavity 12 prior to subsequent installation of the oven cavity 12 into the appliance cabinet 10. Additionally, providing a portion of the sensor 30 outside of the appliance cavity 12 substantially isolates the sensor 30 from airborne contaminants created during cooking and during a self-clean function. Moreover, the sensor 30 is able to withstand contact with temperatures exceeding those incurred during a self-clean. The sensor 30 can provide an electrical circuit that can be interrupted when the rack structure(s) is in place. When the circuit is interrupted, it can be communicated to an oven control, which in turn prevents a self-clean function from initiating. Alternatively or additionally, the interruption of the circuit can trigger a notification can be transmitted to a user to indicate that the rack structure(s) should be removed. Such a notification can be a visual notification on a display of the appliance or as a light located on or near a desired appliance surface. The notification can alternatively or additionally be a visual alert, such as a beep or chime.

An alternative possible implementation includes one in which a portion of the rack structure 14 protrudes through an aperture in the cooking cavity 12 when the rack structure 14 is positioned within the cavity 12. The protruding portion (not shown) can then mechanically operate a switch (not shown) that is advantageously located external to the cavity 12. The switch is thus protected from oven heat.

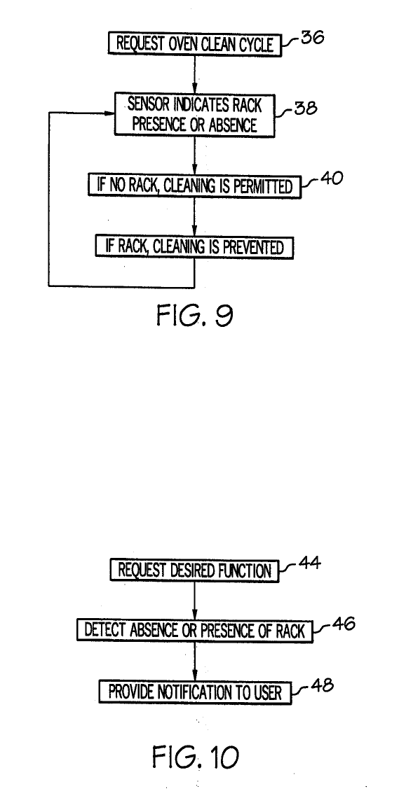

Referring to FIG. 9, an example of the operation of an oven according to the invention includes a user requesting an oven cleaning cycle 36. Based on the indication provided by the sensor 38, a decision is made as to whether a rack structure is present in the oven. If the result is no, an oven cleaning is permitted 40. If the result is yes, the oven cleaning is prevented 42. In addition, when a rack structure being present prevents cleaning, an alert can be provided to signal the user to take corrective action before a cleaning cycle will run (the operation loops back to 38). The alert may be, for example, a visual signal, an audible signal or both.

In accordance with another example, an operation of an oven is illustrated in FIG. 10. A user requests a desired appliance function 44. A sensor then detects a presence or absence of a rack within a cavity of the appliance 46. Based on the detection by the sensor, a notification or alert is provided to the user of the presence or absence of the rack 48. The desired appliance function may or may not be prevented from initiating based on the sensed presence or absence of the rack.

It should be noted that more than one rack structure can be present in the appliance, in which case it would be desirable to sense the presence or absence of each structure that should be removed during cleaning. This would of course remain within the scope of the invention.

The present invention facilitates continuous proper operation of a rack having movable parts. The sensor interacts with the racks to enable or disable a desired operation depending upon whether the racks are present within the appliance.

Although, the above appliance configuration has been substantially described herein as an oven, it is to be appreciated that any other suitable appliance can be configured in a manner similar to that set forth herein. Further, although the configuration discussed herein is operable to prevent a function and/or to provide an alert when one or more rack structures are present, it is to be appreciated that a configuration can be employed in which a function is prevented and/or an alert can be provided when the rack structures are absent from the appliance cavity. As an example, a dishwasher could be provided with one or more rack sensors to prevent operation of the dishwasher if the rack(s) are not properly positioned within the cavity.

What has been described above includes example implementations of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations of the present invention.

It should be evident that this disclosure is by way of example and that various changes may be made by adding, modifying or eliminating details without departing from the scope of the teaching contained in this disclosure. The invention is therefore not limited to particular details of this disclosure except to the extent that the following claims are necessarily so limited.

1. An appliance comprising:
a housing;
a cavity within the housing, the cavity being configured to receive at least one removable structure therein; and
at least one sensor configured to detect the presence and/or absence of the at least one removable structure within the cavity.

2. The appliance of claim 1, further comprising an indicator, the indicator configured to provide notification to a user in response to the detection of the presence and/or absence of the at least one removable structure.

3. The appliance of claim 2, wherein the notification comprises an audible alert.

4. The appliance of claim 2, wherein the notification comprises a visual alert.

5. The appliance of claim 1, wherein the at least one sensor is operatively coupled to a control device to prevent engagement of a selected function based on the detection of the presence and/or absence of the at least one removable structure in the cavity.

6. The appliance of claim 1, wherein the at least one removable structure is a ladder rack.

7. The appliance of claim 1, wherein the at least one removable structure is a support rack.

8. The appliance of claim 1, wherein the at least one sensor is coupled to an exterior portion of the appliance cavity.

9. The appliance of claim 1, wherein the appliance is an oven.

10. The appliance of claim 9, wherein the at least one sensor is capable of withstanding temperature exceeding those incurred during a self-clean function of an oven.

11. A method for operating an appliance comprising:
requesting a desired function;
sensing an absence or presence of a removable structure within a cavity portion of the appliance; and
providing notification to a user of the absence or presence of the removable structure within the cavity portion of the appliance.

12. The method of claim 11, wherein the notification is provided to the user via an audible alert.

13. The method of claim 11, wherein the notification is provided to the user via a visual alert.

14. The method of claim 11, further comprising preventing operation of the desired function when the presence of the removable structure is sensed within the cavity portion of the appliance.

15. The method of claim 11, further comprising preventing operation of the desired function when the absence of the removable structure is sensed within the cavity portion of the appliance.

16. An appliance comprising:
means for detecting a presence or absence of a removable structure within a cavity portion of the appliance; and
notification means for alerting a user of the presence of absence of the removable structure within the cavity portion of the appliance.

17. The appliance of claim 13, further comprising control means for controlling an operation of the appliance based on the detection of the presence of absence of the removable structure.
